(19) United States
(12) Patent Application Publication
(10) Pub. No.: US 2014/0170483 A1
(43) Pub. Date: Jun. 19, 2014

(54) METHOD FOR THE PREPARATION OF GRAPHENE/SILICON MULTILAYER STRUCTURED ANODES FOR LITHIUM ION BATTERIES

(71) Applicants: Yuegang Zhang, Cupertino, CA (US); Liwen Ji, Richland, WA (US); Ariel Ismach, Austin, TX (US)

(72) Inventors: Yuegang Zhang, Cupertino, CA (US); Liwen Ji, Richland, WA (US); Ariel Ismach, Austin, TX (US)

(73) Assignee: The Regents of the University of California, Oakland, CA (US)

(21) Appl. No.: 14/005,208

(22) PCT Filed: Mar. 15, 2012
(86) PCT No.: PCT/US12/29274

§ 371 Date: Feb. 4, 2014

Related U.S. Application Data
(60) Provisional application No. 61/453,295, filed on Mar. 16, 2011.

(51) Int. Cl. H01M 4/36; H01M 4/04

(52) U.S. Cl. CPC H01M 4/366; H01M 4/0428
USPC 429/211; 429/231.8; 427/77

(57) ABSTRACT

Multilayer structures with alternating graphene and Si thin films were constructed by a repeated process of filtering liquid-phase exfoliated grapheme film and subsequent coating of amorphous Si film using plasma-enhanced chemical vapor deposition (PECVD) method. The multilayer-structure composite films, fabricated on copper current collectors, can be directly used as anodes for rechargeable lithium-ion batteries (LIBs) without the addition of polymer binders or conductive additives. Fabricated coin-type half cells based on the new anode materials easily achieved a capacity almost four times higher than the theoretical value of graphite even after 30 cycles. These cells also demonstrated improved capacity retention and enhanced rate capability during charge/discharge processes compared to those of pure Si film-based anodes.

### CROSS REFERENCE TO RELATED APPLICATIONS

This application claims priority to PCT Application PCT/US2012/029274, filed Mar. 15, 2012, which in turn claims priority to U.S. Provisional Application Ser. No. 61/453,295 filed Mar. 16, 2011, which application is incorporated herein by reference as if fully set forth in their entirety.

### STATEMENT OF GOVERNMENTAL SUPPORT

The invention described and claimed herein was made in part utilizing funds supplied by the U.S. Department of Energy under Contract No. DE-AC02-05CH11231 between the U.S. Department of Energy and the Regents of the University of California for the management and operation of the Lawrence Berkeley National Laboratory. The government has certain rights in this invention.

### BACKGROUND OF THE INVENTION

1. Field of the Invention

This invention relates generally to improved electrodes for lithium ion batteries and methods for making same. More particularly it relates to a multilayer composite electrode fabricated on a copper current collector comprising alternating layers of graphene sheets and silicon. In one embodiment graphene sheets are formed into three dimensional structures, the sheets then coated with silicon, with the process repeated several times until the desired number of alternating layers has been obtained.

2. Brief Description of the Related Art

Due to the exponential growth in global energy consumption, rapid depletion of fossil fuels, concomitant growth in greenhouse gas emissions, and the upward spike in the prices of crude-oil and gasoline, significant concerns and efforts have been focused on the development of clean and renewable energy sources and advanced energy storage technologies.

Further development of high-performance rechargeable lithium-ion batteries (LIBs) is indispensable for the ever growing needs for electric vehicles (EV), hybrid electric vehicles (HEV) and plug-in hybrid electric vehicles (PHEV). Remarkable research efforts have been devoted to improving the already incomparable performance of rechargeable LIBs which are ubiquitous in various fields since its successful commercialization about 20 years before.^{[1-6]} The most popular graphite-based anodes, with a theoretical specific capacity of 372 mAh/g, are commonly used in commercially available rechargeable LIBs along with several types of Li oxide based cathodes (less than 170 mAh/g specific capacity). However, current graphite and transition metal oxide based electrodes only provide moderate energy-storage capability and therefore it is difficult for them to meet the increasing demands for advanced energy storage. Hence, it is essential to design and synthesize new anode materials that can offer the promise of high-performance LIBs with elevated efficiency, superior storage capacity and gravimetric energy density, longer cycle life, easier state-of-charge control, lower cost, and safer operation.

Silicon-based electrodes for rechargeable LIBs have attracted considerable attention because they are able to vastly improve the specific capacity of batteries. As a naturally abundant element, silicon has the highest theoretical specific capacity among all exiting materials, which can reach 4200 mAh g⁻¹ in the form of Li_{4.4}Si. Furthermore, Si is also inexpensive, easy to handle, and has low discharge potential when used as an anode for rechargeable LIBs. These unique attributes endow Si with one of the most promising candidates to replace graphite as the anode for high performance rechargeable LIBs.

Unfortunately, its potential in broad commercial applications has been hindered by severe capacity fading and loss of electrical contact caused by huge volume change, structural crumbling, and even cracking during repeated charge and discharge cycling, especially at high current rates. Downsizing from conventional bulk silicon to various nanoscale morphologies and structures or dispersing these nanostructured Si into carbon matrices are among the most appealing approaches being pursued to overcome these issues and to improve the overall electrochemical performance of Si-based anodes in rechargeable LIBs. Here, the size reduction can help to accommodate the volume change, release the huge stresses in the Si particles during continuous insertion/extraction processes, facilitate more efficient electronic/ionic diffusion, provide more active sites, and enhance structural flexibility as well, while the carbon component in the Si/carbon nanocomposite electrodes can create a conducting matrix to maintain the electrical contact of the electrode with the current collector, resulting in better endurance during charge/discharge cycling. In addition, the incorporation of Li-active Si into carbon-based electrodes can reduce the initial irreversible capacity, and improve both the Coulombic efficiency and cycling performance of anodes even at high current densities.

Graphene, a new class of two-dimensional, “aromatic,” monolayer of carbon atoms densely packed in a honeycomb crystal lattice, has attracted unmatched attention and has also triggered tremendous experimental activities for applications in next generation electronic and energy storage devices, owing to its exceptional properties including extraordinarily high electronic mobility, outstanding optical transparency, unique electronic structures, intriguing thermal conductivity, and amazing mechanical strength as well as ultrahigh surface area.^{[38-43]} Hence, graphene could be superior to other carbon materials as a conductive matrix to enhance electron transport and electrical contact with Si active materials in rechargeable LIBs and to effectively prevent the volume expansion/shrinkage and aggregation of Si phases during the Li charge/discharge processes. Furthermore, its large surface area can also facilitate the absorption of Li atoms on both sides of the graphene sheet or into its ubiquitous cavities. As a result, the merits of both carbon and Si phases can be extended to the largest extent based on their synergetic effects.

Recently, Chou et al. (S.-L. Chou, J.-Z. Wang, M. Choucair, H.-K. Liu, J. A. Stride, S.-X. Dou, Electrochemistry Communications 2010, 12, 303) blended commercially available nanosized Si particles and graphene to prepare eco-friendly and low cost LIB anodes, which exhibited enhanced cycling stability. In the meantime, several other groups also successfully prepared Si nanoparticles/graphene paper composite as anodes for rechargeable LIBs with high Li storage capability and cycling stability. (See J. K. Lee, K. B. Smith, C. M. Hayner, H. H. Kung, Chemical Communications 2010, 46, 2025: G. Wang, B. Wang, X. Wang, J. Park, S. Dou, H. Ahn, K. Kim, Journal of Materials Chemistry 2009, 19, 8378) The studies also indicated that graphene can be used to anchor electrochemically active transition metal oxides or metal nanoparticles as anode materials for rechargeable LIBs, and these batteries exhibit enhanced cycle life and improved reversible capacity. See, for example, US Published Patent Application 2011/0033746, filed Aug. 10, 2009. The use of Si nanoparticles, however, may not provide a simple way to optimize the ion transport in the anode, especially when the loading of Si is high. Furthermore, required is the use of inactive binders to hold the Si and Carbon components together, which serves to reduce the overall energy capacity.

### SUMMARY OF THE INVENTION

By way of this invention, a simple multilayer structure has been fabricated by alternating graphene films and Si layers (as schematically shown in FIG. 1). The flexible graphene films are designed to buffer the structural changes caused by volume expansion and contraction of Si layers during the Li alloying/de-alloying processes. In addition, the graphene-film layers isolate each Si layer, circumventing the Si aggregation problem. This facile approach is designed to provide an optimized graphene/Si nano-architecture where the graphene-film layers function as a flexible mechanical support to mitigate and accommodate the volumetric-change-induced stresses/strains in the Si layer and therefore, alleviate or even avoid the pulverization of Si phase, maintaining the structural integrity of the electrodes at the same time. Additionally, this reinforcing material offers an efficient, electrically-conducting medium and effectively improves the adhesion strength between different active materials and also with the Cu foil current collector.

As described in more detail hereinafter, graphene films are first obtained via filtering liquid phase exfoliated graphene. Subsequently, the graphene film is directly transferred to copper foil-based current collector. Finally, a Si film is deposited onto the graphene film surface via a Plasma Enhanced Chemical Vapor Deposition (PECVD) system. Such filtering-transferring and PECVD processes can be repeated several times, (e.g. 3-5 times) to prepare layered graphene/Si structure.

### BRIEF DESCRIPTION OF THE DRAWINGS

The foregoing aspects and others will be readily appreciated by the skilled artisan from the following description of illustrative embodiments when read in conjunction with the accompanying figures.

FIG. 1 is a schematic illustration of preparation procedures for the formation of the composite electrode of this invention by the repeated stacking of graphene followed by the deposition of a silicon layer.

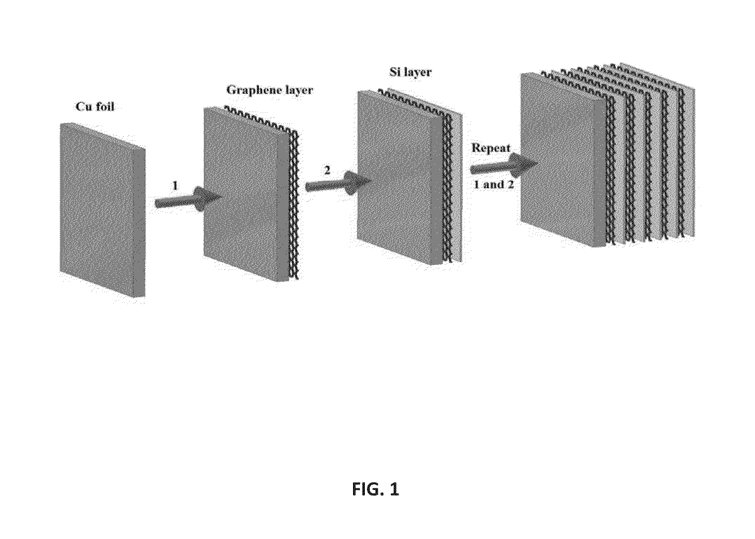

FIG. 2 are SEM images of (a), (b) graphene sheets prepared from liquid-phase exfoliating graphite; (c), (d) are images of PECVD Si on copper; and (e), (f) are images of multilayer graphene/Si structures.

FIG. 3 are cross-sectional SEM images of multilayer graphene/Si structures: (a) and (b) showing repeated graphene/Si layer structures, (c) showing graphene-Si-graphene structures and (d) showing Si-graphene-Si structures.

FIG. 4 is a series of plots showing: (a) CV curve of a five-layer graphene/Si structure anode with 0.1 mV s⁻¹ scanning rate in the potential window from 2.8 V to 0.002 V (vs. Li⁺/Li); (b) galvanostatic charge/discharge profiles of five-layer graphene/Si structures, (c) pure PECVD Si films, and (d) pure graphene films at a cycling rate of C/40 with a cutoff voltage window of 2.8 V to 0.002 V.

FIG. 5 are cross-sectional SEM images of five-layer graphene/Si multilayer structures after 50 cycles at C/40 rate with a cutoff voltage window of 2.8 V to 0.002 V.

FIG. 6 are plots of galvanostatic charge/discharge profile of (a) three-layer graphene/Si structures, and (b) one-layer graphene/Si structures at a cycling rate of C/40 with a cutoff voltage window of 2.8 V to 0.002 V.

FIG. 7 are plots of (a) cycling performance and (b) rate capabilities of half cells with five-layer graphene/Si structures as anodes at different cycling rates with a cutoff voltage window of 2.8 V to 0.002 V.

FIG. 8 are plots of voltage profiles of a full cell using a LiNi_{1/3}Mn_{1/3}Co_{1/3}O₂ cathode and a five-layer graphene/Si structured anode, with an initial cycling rate of C/15 for 5 cycles (a), followed by a continuous 15 cycles at C/4 (b), and the corresponding cycling performance curve (c). The specific capacity is calculated according to the mass of five-layer graphene/Si structured anode.

FIG. 9 is a plot of an XRD pattern for a prepared graphene/Si multilayer structure according to a method of the invention. The graphite peak is from the residues of incomplete exfoliation of graphite particles.

### DETAILED DESCRIPTION

By way of the present invention, graphene/Si layer structures were prepared by a repeating process of filtering liquid-phase exfoliated graphene and the subsequent coating of each graphene layer with amorphous Si films using in one embodiment plasma enhanced chemical vapor deposition. When directly used as anodes for rechargeable lithium ion batters, these materials can deliver a large charge and discharge capacity of about 2728, and 2232 mAh g⁻¹ respectively at the first cycle with high coulombic efficiency of 82% at 50 mAg⁻¹. As tested, at 30 cycles, the reversible capacity is still as large as 1320 mAh g⁻¹.

The graphene/Si multilayer structures of the invention were prepared using graphite powder, N-Methyl-2-pyrrolidone (NMP), and sodium hydroxide (NaOH) purchased from Sigma-Aldrich. Anodic aluminum oxide (AAO) membrane was obtained from Whatman Inc. (Piscataway, N.J.). In one embodiment, graphite was dispersed in NMP solvent at a concentration of 0.4 mg/ml by sonicating in a power sonic bath (Model 75 D) for 120 minutes. Care is to be taken in this step to avoid excessive sonication which can lead to destruction of the graphene. The resultant dispersion was centrifuged using an Allegra X-22 centrifuge for 30 minutes at 1000 rpm. After centrifugation, decantation was carried out by pipetting off the top half of the dispersion. For a further discussion of obtaining graphene via liquid phase exfoliation, see Hernandez, Y.; Nicolosi, V.; Lotya, M.; Blighe, F. M.; Sun, Z.; De, S.; McGovern, I. T.; Holland, B.; Byrne, M.; Gun'Ko, Y. K.; Boland, J. J.; Niraj, P.; Duesberg, G.; Krishnamurthy, S.; Goodhue, R.; Hutchison, J.; Scardaci, V.; Ferrari, A. C.; Coleman, J. N., High-yield production of graphene by liquid-phase exfoliation of graphite. Nat Nano 2008, 3, (9), 563-568.

The prepared graphene NMP solution was filtrated directly by utilizing an AAO membrane with a pore size of 20 nanometers. The vacuum filtration of the as-prepared graphene dispersions in NMP resulted in the formation of graphene films on the AAO membrane. After removing the AAO membrane with NaOH solution and repeated rinsing with distilled water, these thin graphene films with a thickness of about 600 nm were directly transferred to copper foil-based current collectors.

Afterwards, the amorphous Si films were deposited on the above-prepared graphene film surface via a plasma-enhanced chemical vapor deposition (PECVD) system (Oxford Instruments) with 10% SiH₄ (silane) several times as precursors in argon atmosphere at about 350° C. (Usually this PECVD process can take about 15 minutes, leading to about 500˜1000 nm thick Si films). Subsequently, the same processes were repeated, in one experiment three times, and in another experiment five times to prepare three layered, and five layered graphene/Si composite respectively on copper foil-based current collectors.

For comparison purposes, also prepared using the filtration process described above was pure filtrated graphene on copper foils, as well as PECVD of Si films on copper foils. Here, in order to decrease the possible experimental error in the electrochemical measurements, both the pure graphene and PECVD films contained the same ingredients with the corresponding components in five layer graphene/Si structures, made to the same thickness. These multilayered graphene /Si structures, pure grapheme films, and PECVD Si films on copper foils were pressed at very large pressure, e.g. around 30 psi or more in order to make the active materials have good contact with Cu foil current collector, and then directly used for characterization and rechargeable LIB tests.

The morphologies and microstructures of as-prepared graphene film, PECVD Si film, and the graphene/Si multilayer structures were investigated by scanning electron microscopy (SEM: Zeiss Gemini Ultra-55) with energy dispersive X-ray spectroscopy (EDS) and X-ray diffraction (Diffraktometer D500/501, Siemens).

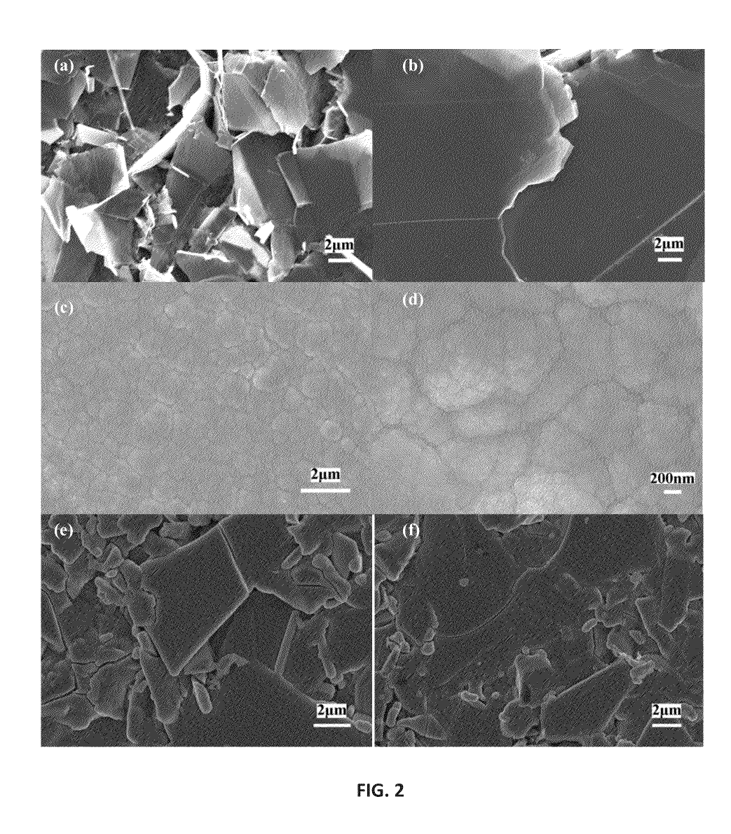

FIG. 2(a) and (b) shows the morphology of a pure graphene film on copper foil. Both nano-scaled and micro-scaled sheets are present in the film, which pile up randomly. The morphology of the pure PECVD Si film on copper foil is shown in FIG. 2 (c) and (d). The film is amorphous and composed of small and large clusters. The uneven and roughened surface could have been inherited from the underlying copper foil. FIG. 2 (e) and (f) are the planar-view SEM images of the as-prepared graphene/Si multilayer structures with the silicon layer deposited on the graphene segments by PECVD. The corresponding energy dispersive X-ray spectroscopy (EDS) analysis confirms the existence of the Si phase in the prepared graphene/Si multilayer structures, indicating that the PECVD Si films were coated on the graphene film.

A comparison of FIG. 2 (a) and (b) with (e) and (f) clearly shows that the top-layer Si film in the multilayer structure inherited the surface morphology of the underlying graphene flakes. In contrast to the rough surface of Si coated onto copper foil, the Si coating on graphene sheets is very smooth and conformal, indicating good adhesion of Si onto the graphene surface.

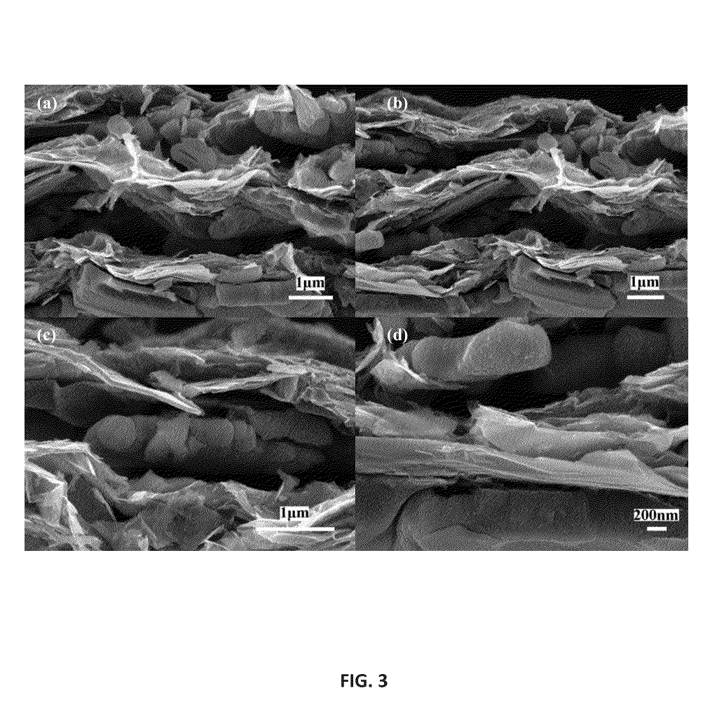

The alternating graphene and Si layers of the multilayer samples are clearly shown in the cross-sectional SEM images in FIG. 3. The graphene sheets are loosely stacked into continuous films without apparent stacking order. Voids of different sizes along with large amounts of cavities and defects can be observed in both the graphene layer and the Si layer (it should be noted that some big cracks between graphene films and Si layers were introduced by the cutting process during the preparation of the cross-sectional SEM samples). The measured single layer thickness for both graphene and Si films is about 500 nm, consistent with their nominal values. As a result, the as-formed one, three, five layer graphene/Si structures should have thickness at around 1, 3, 5 μm, respectively.

Having formed a number of multi layer electrodes, the electrodes were formed into half cells and electrochemical measurements taken. More particularly, 2032 coin-type half cells were assembled with the prepared graphene/Si multilayer structures, pure grapheme films alone, and PECVD Si films on copper as the electrode active materials in a high-purity argon-filled glove box. Thin Li foil (0.5 mm thick, FMC lithium) was employed as the counter electrode and a polypropylene membrane (Celgard 2400) was used as the separator. The electrolyte was 1 M lithium hexafluorophosphate (LiPF₆), dissolved in 1/1 (V/V) ethylene carbonate/ethyl methyl carbonate (EMC) (Ferro Corp.). Type 2032 coin-type full cells with commercially available LiNi_{1/3}Mn_{1/3}Co_{1/3}O₂ as cathodes and the graphene/Si multilayer structures as anodes were also assembled in a high-purity argon-filled glove box.

The tested cathodes were prepared by mixing LiNi_{1/3}Mn_{1/3}Co_{1/3}O₂, carbon black, and polyvinylidene difluoride (PVDF) at a weight ratio of 80:10:10 in NMP solvent to form a slurry. The resultant slurry was uniformly pasted on pure alumina foil and first dried at 70° C. for 12 hours and then at 130° C. for 16 hours. Cyclic voltammogram measurements were performed on an AQ4 Gamry Reference 600 electrochemical workstation with a voltage range from 0.002 to 2.80 V at a scan rate of 0.1 mV s⁻¹. Galvanostatic charge (lithium alloying) and discharge (lithium de-alloying) experiments of the half-type coin cells were conducted using an Arbin automatic battery cycler at several different current densities between cut-off potentials of 0.002 and 2.80 V. For the cycling tests of the coin-type full cells, the charge cutoff voltage ranged from 3.0 to 4.3 V. All of the electrochemical performance measurements were obtained at a constant temperature of 24° C.

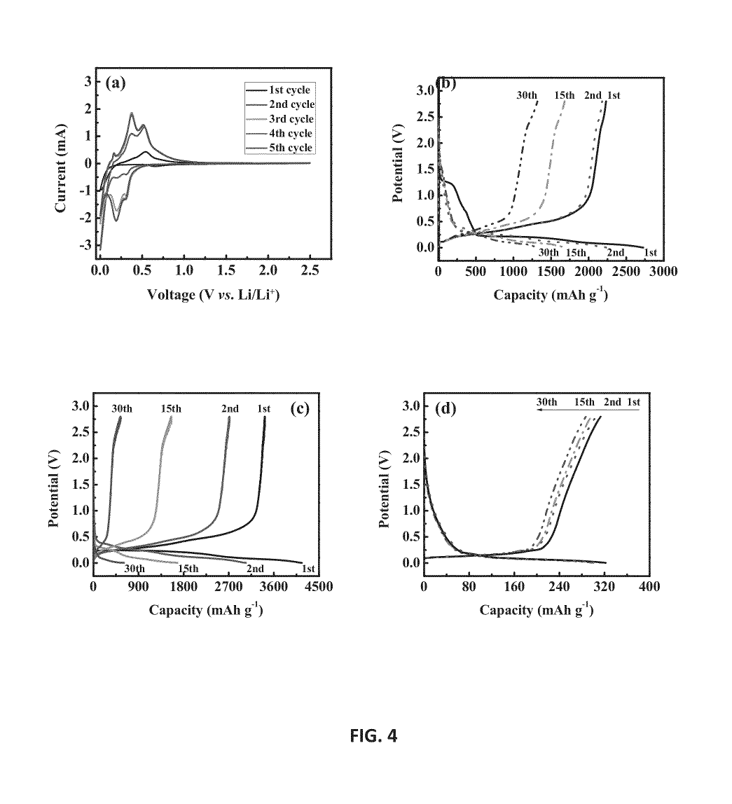

The graphene /Si multilayer structures (including five layers, three layers and one layer), containing about 56 wt % Si and 34 wt % graphene, were directly used as anodes without adding any polymer binders and conductive additives for coin-type half cells with Li foils as counter electrodes. FIG. 4 (a) displays typical slow scan rate (0.1 mV s⁻¹) cyclic voltammogram (CV) curves of a coin-type half cell obtained from a five layer graphene/Si structure anode. It is noted that the first cycle reduction scanning curve was significantly suppressed and only has a weak and broad peak, while the first cycle oxidation scanning curve has a clear peak at about 0.6V. Two new reduction peaks at 0.2/0.3V and another new oxidation peak at about 0.45 V appeared at the second cycle redox scanning curve. In the subsequent cycles, these oxidation/reduction peaks settled rapidly and maintained a steady pattern eventually resulting in the peaks overlapping one another. The initial flat reduction curve at the first cycle could be due to the formation of a solid electrolyte interface (SEI) film on the surface of the electrodes and could also be due to the initially inactivated surface acting against the electrochemical reaction. This inactivated nature of the Si surface at beginning of the redox reaction cycles diminishes gradually during the continuous CV scanning (insertion/extraction processes). As a result, several peaks were recognized on potential scanning branches toward both anodic and cathodic potentials in the subsequent cycles. These peaks were attributed to the potential dependent formation and disappearance of Li—Si alloys with different compositions.

FIG. 4 (b) summarizes the charge (lithiation) and discharge (delithiation) capacity profiles at C/40 (50 mA g⁻¹) with a potential window from 0.002 V to 2.8 V for a different half cell with a five layer graphene/Si structure as the anode. It is remarkable to note that a very high first cycle galvanostatic charge/discharge capacity value of about 2728 and 2232 mAh g⁻¹ was obtained, corresponding to a high Coulombic efficiency of about 81.82%, which is larger than the previously reported results for graphene/Si composite anodes. (See L. S.-L. Chou, J.-Z. Wang, M. Choucair, H.-K. Liu, J. A. Stride, S.-X. Dou, Electrochemistry Communications 2010, 12, 303: and J.-Z. Wang, C. Zhong, S.-L. Chou, H.-K. Liu, Electrochemistry Communications 2010, 12, 1467). The irreversible capacity ratio of 18.18% can be assigned to the reductive decomposition of the electrolyte, forming a SEI film on the electrode surface. It was also noted that during the first charge process, the voltage steeply decreased to about 0.20-0.30V, followed by a slow decrease to 0.002 V. It should be noted that the plateau at 1.3 V on the 1st cycle charging curve of this specific sample could be due to the residual Al₂O₃ components from AAO filters.

During the subsequent cycles, the charging/discharging profiles showed smooth sloping curves. These phenomena are consistent with previously reported electrochemical behavior of Si-based anodes. During the second cycle, these materials delivered a reversible capacity of 2180 mAh g⁻¹, corresponding to a 97.7% capacity retention. In addition, a large Coulombic efficiency of about 98% was obtained at the second cycle, and this value was also preserved in subsequent cycles. At the 15^{th} and 30^{th} cycles, the discharge capacities were about 1683 and 1320 mAh g⁻¹, respectively, retaining 75.4% and 59.2% of the initial capacity value.

For comparison, the electrochemical evaluations of both the as-prepared pure graphene film and PECVD Si films were carried out. The results are displayed in FIG. 4(c) and (d). The pure Si film exhibited near theoretical charge/discharge capacities of about 4159 and 3418 mAh g⁻¹ at the first cycle with a Coulombic efficiency of about 82.18% (FIG. 4(c)). After that, the capacity began to fade dramatically. For example, at the second cycle, the discharge capacity decreased to 2712 mAh g⁻¹, a 79.3% capacity retention of the first cycle value. At the 15^{th} and 30^{th} cycles, the reversible capacity can only be preserved at about 1554 and 541 mAh g⁻¹, respectively, indicating only 45.5% and 15.8% capacity retention of the initial value. The pure graphene film anode had a relatively lower capacity (the reversible capacity was about 313 mAh/g at the first cycle), but good capacity retention (the value was about 287 mAh g⁻¹ at the 30^{th} cycle) (FIG. 4(d)), which is similar to other reported results. The different Li-storage capacity of different reported graphene samples may be due to the different microstructure, crystallization, and/or layer staking density of the graphene-containing carbon materials.

It has been reported that in pure Si film-based anodes, the continuously large volume changes always accompanying charging/discharging processes leads to the agglomeration of Si and causes microstructure changes that gradually destroy the electrical contact of the Si films with the current collector. As a result, severe capacity fading follows. In the graphene/Si multilayer structures of the invention, the Si thin-films were confined by the graphene-film layers in between, which serve as structural buffers to relax the huge mechanical stress induced during cycling and prevent continuous disintegration, fragmentation, and aggregation of Si so that the excellent structural and electrical integrity of the electrodes is preserved upon continuous charging/discharging. As a result, the graphene/Si multilayer structures described herein have demonstrated improved cycle life and enhanced rate capability.

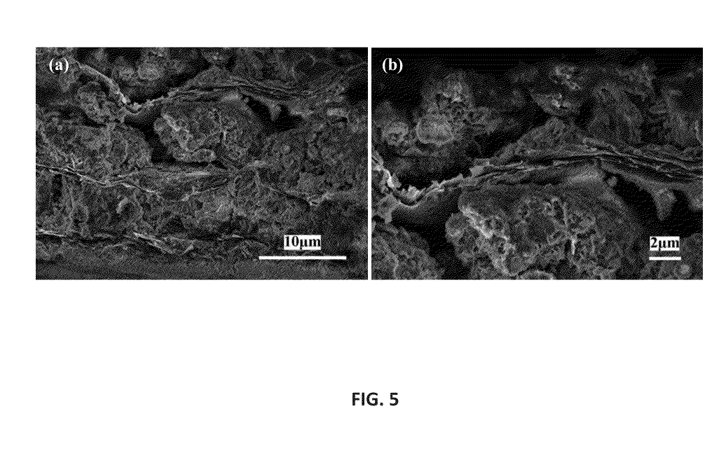

The structure-confinement effect of the graphene films on the volume change of Si is evident in FIG. 5, where the cross-sectional SEM images show that the graphene/Si multilayer anode preserved its general structure after 50 cycles of lithiation/delithiation at a C/40 rate between 2.8-0.002V. Comparing with the as-deposited structures in FIG. 3, we observed significant thickness increases of the Si films in the cycled samples. The expanded Si layers suppressed the graphene-film layers into more tightly packed sheets. The mechanical constraint from the flexible yet strong graphene sheets prevented the three-dimensional agglomeration of Si between different layers and hence suppressed further shape change of Si layers (except for the thickness increase), which led to good electrical contacts of all components in the anode. Although the microstructural changes (corrugation and agglomeration) within the Si layer due to the repetitive Li insertion/removal process were observed, distinct Si buckling and clear delamination are absent even with the relatively thick Si layers. As a result, catastrophic structure degradation along with severe capacity fading were avoided. Through judicious control of the Si layer thickness, it is expected structural changes in the Si phase can be further minimized in the graphene/Si multilayer structures.

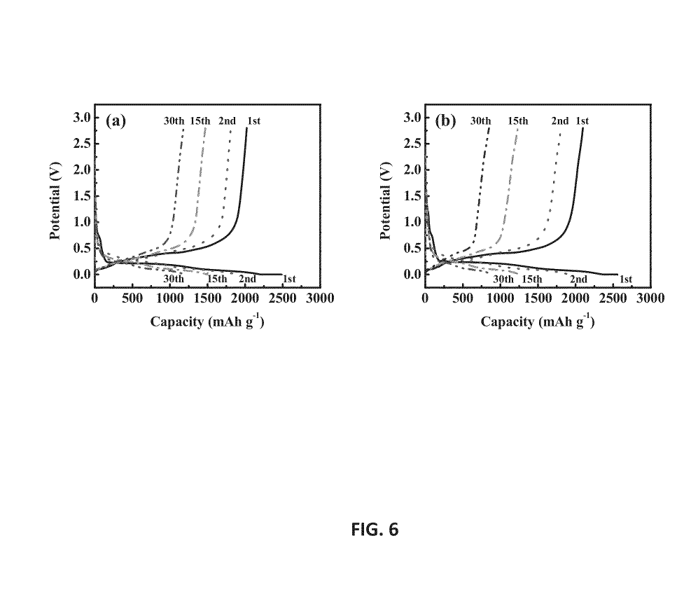

To understand the influence of the number of graphene/Si layers on capacity retention, also measured were the charge/discharge profiles of anodes made of three layers and one layer of graphene/Si structures under the same conditions. The results are summarized in FIG. 6 (a) for three layers and (b) for one layer. Both samples showed large reversible capacities of 2023 and 2098 mAh g⁻¹ at the first cycle, with corresponding Coulombic efficiencies of about 81.3% and 82.0%, respectively. These values are comparable to the five-layer graphene/Si anodes. At the second cycle, these materials had reversible capacities of about 1809 and 1804 mAh g⁻¹, representing about 89.4 and 86.0% capacity retentions compared with their first cycle values. These reversible capacities decreased to 1181 and 848 mAh g⁻¹ at the 30^{th} cycle, indicating 58.1% and 40.4% capacity retention of their first cycle values. These results suggest that the capacity fading of graphene/Si multilayer structures can be further reduced by increasing the number of graphene/Si layers.

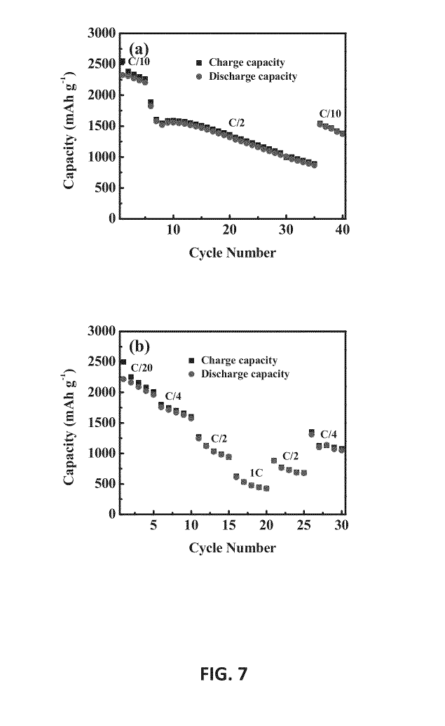

In order to demonstrate the high-rate capability of the graphene/Si multilayer structures, cycle performance tests were conducted at various charge/discharge rates. FIG. 7 (a) and (b) show the rate capability results for two samples of five layer graphene/Si structures. In FIG. 7 (a), disclosed is that the discharge capacity at C/10 was 2326 mAh g⁻¹ at the first cycle and dropped to 2205 mAh/g at the 5^{th} cycle at the same rate. The discharge capacity at C/2 started with a high value of 1821 mAh g⁻¹ as well as a high Coulombic efficiency of 96.5%. This value slowly decreased to 865 mAh g⁻¹ after 30 cycles. The subsequent charge/discharge process at C/10 lead back to a reversible capacity of 1526 mAh g⁻¹. FIG. 7 (b) shows the galvanostatic rate capability of another five layer graphene/Si structure-based anode in a coin-type half cell. At a C/20 rate, the material delivered a large first cycle discharge capacity of about 2218 mAh g¹. After the cell was cycled at this rate for 5 cycles, the C-rate was increased stepwise to C/4, C/2, 1C, respectively. Under these rates, the graphene/Si multilayer anode had an initial reversible capacity of about 1801, 1271 and 627 mAh g⁻¹, respectively. Decreasing the C-rate back to C/2 and C/4 caused the initial reversible capacity to increase back to 883 and 1354 mAh g⁻¹, respectively, showing reasonably good high-rate capability.

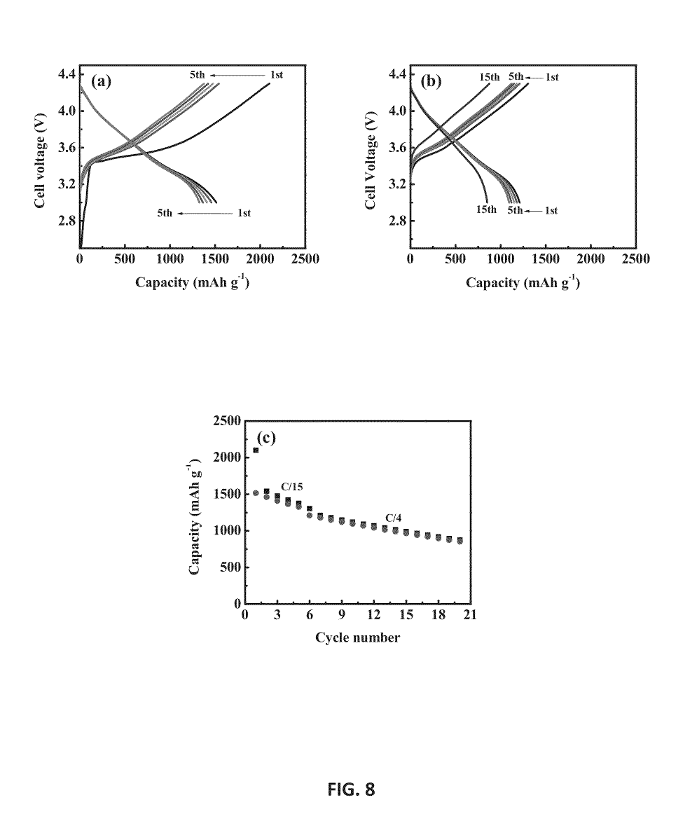

To demonstrate practical application, a full cell Li-ion battery utilizing commercially available LiNi_{1/3}Mn_{1/3}Co_{1/3}O₂ in the cathode and the five layer graphene/Si structures as the anode was assembled and the electrochemical performance of the full cell evaluated. FIG. 8 demonstrates the voltage profiles and the corresponding cycling performance of the five layer graphene/Si anodes of the full cell, where the specific capacities are calculated according to the mass of anode. The cycling rate used in the initial five cycles was C/15 and C/4 for the following 15 cycles. Here, 1C=180 mA g⁻¹ according to the previously measured capacity of the LiNi_{1/3}Mn_{1/3}Co_{1/3}O₂—based cathodes. In order to balance the full cell, the mass loading of the cathode (LiNi_{1/3}Mn_{1/3}Co_{1/3}O₂) is about 20 mg, while the weight of the as-prepared 5-layer graphene/Si structure active materials is at around 1.8 mg. Accordingly, in this full cell, the specific capacity according to the weight of LiNi_{1/3}Mn_{1/3}Co_{1/3}O₂ is about 180 mAh/g and the value of the corresponding 5-layer graphene/Si structures is about 2000 mAh/g.

From the charging/discharging curves in FIG. 8 (a), it is apparent that the specific capacity, according to the weight of multi-layer graphene/Si structure anodes, was 1514.8 mAh g⁻¹, with an initial Coulombic efficiency of 72.05% at C/15; the specific capacity and Coulombic efficiency were 1326.2 and 97.7%, respectively, at the 5^{th} cycle under the same rate. After that, the cycling rate was increased to C/4, and the specific capacity could still be preserved at about 1210 mAh g⁻¹ after the first cycle with a high Coulombic efficiency of 92.8% (FIG. 8 (b)). After 15 cycles at this C-rate, the full cell still has a specific capacity of 852.3 mAh g⁻¹, indicating a capacity retention of about 70.4%.

The cycle performance of the multi-layer graphene/Si structures/LiMn_{1/3}Co_{1/3}Ni_{1/3}O₂ full cell at C/15 (initial five cycles) and C/4 (the following 15 cycles) is shown in FIG. 8 (c). These results show a gently sloping curve, indicating relatively good capacity retention. In addition, the cycle life curve shows that after the initial six cycles, these prepared full cells have very high Coulombic efficiency. Although these initial results were slightly behind some of the recently reported electrochemical results of Si-based anodes in full cells, they are still quite comparable to commercially available full cells using graphite as their anodes. Better results can be expected through improvement and optimization of the graphene/Si multilayer structures, including the layer thickness and the number of layers.

In summary, Graphene/Si multilayer structures were constructed by filtrating liquid-phase exfoliated graphene films and then depositing Si films by PECVD. These graphene and Si alternating multilayered structures were used as binder-free electrodes for rechargeable LIBs and exhibited a large reversible capacity along with improved rate capabilities and cycling characteristics. It was demonstrated that the highly compliant and flexible graphene layers offer enhanced stress and strain resilience during charge/discharge cycling and thereby improve the structural stability and integrity of the composite anodes. This ductile graphene matrix also serves as an interfacial adhesion layer and provided an efficient electrical conducting pathway and mechanical support to prevent capacity fading by keeping good electrical contact between the different layers. Incorporating dissimilar functional materials into one entity has provided the advantages of short lithium-ion diffusion pathways, large surface areas, and extremely appealing surface activities, allowing improved rate capabilities and cyclic characteristics. Further investigation based on such platform structures could lead to even further improved LIBs with more stable cycle life along with much faster charge-discharge kinetics.

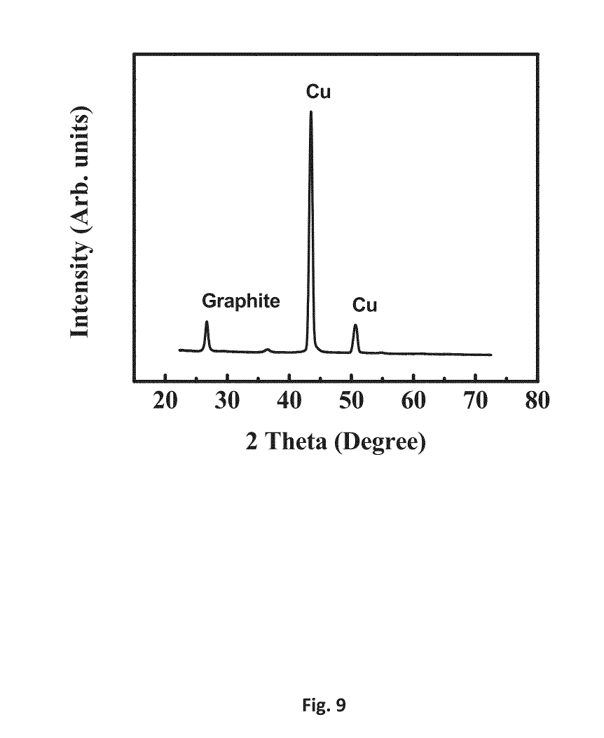

It should be appreciated that as noted above, the as-deposited PECVD Si films were amorphous, as indicated by its X-Ray diffraction pattern, as depicted in FIG. 9. It is not necessary to the operability of the invention, however, that the Si layer be amorphous, and that any portion of the as-deposited Si layer could likewise be crystalline. Further, formation of the Si film layer can be by means other than PECVD, such as thermal CVD, E-beam evaporation, and sputtering. As for the number of layers, the methods of the invention can be used for the construct of electrodes of any desired number. Optimization will in part be a function of battery type, and other factors such as cost, with optimizations within skill of the art.

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself.

We claim:

1. A multi-layered article, comprising, in order:
a layer of graphene film; and
a conformal layer of silicon.

2. The article of claim 1 wherein the silicon film comprises amorphous silicon.

3. The article of claim 2 wherein the graphene film comprises exfoliated graphene.

4. An article of manufacture for use as an electrode in a lithium ion battery comprising:
a current collector substrate;
a layer of graphene film directly applied to said substrate;
a layer of conformal silicon film; and,
one or more additional alternating layers of conformal graphene and silicon film.

5. The article of manufacture of claim 4 wherein the current collector substrate comprises copper.

6. The article of manufacture of claim 5 wherein the silicon film comprises amorphous silicon.

7. The article of manufacture of claim 6 wherein the graphene film comprises exfoliated graphene.

8. The article of manufacture of claim 7 wherein the one or more alternating layers comprises 2 layers.

9. The article of manufacture of claim 7 wherein the one or more alternating layers comprises 4 layers.

10. A method for preparing a composite structure comprising a copper foil and one or more layers of a graphene film coated with a silicon film, said method comprising:
a. forming a graphene film of graphene flakes;
b. transferring the graphene film directly to a copper foil; and,
c. depositing a silicon film on said graphene film by plasma enhanced chemical vapor deposition.

11. The method of claim 10 wherein silane gas is subject to plasma enhanced chemical vapor deposition to form said silicon film.

12. The method of claim 11 where the as-deposited silicon film comprises amorphous silicon.

13. The method of claim 10 wherein the graphene film is formed by filtering a liquid phase exfoliated graphene.

14. The method of claim 10 wherein a second film of exfoliate graphene is formed, and transferred to said first deposited silicon film, followed by the deposition of a second silicon film onto the second deposited graphene film.

15. The method of claim 14 in which at least one additional layer of graphene and silicon are formed and deposited over the first two alternating layers of graphene and silicon.

16. The method of claim 14 comprising the further step of compressing the alternating layers of graphene and silicon.
